(19) United States
(12) Patent Application Publication
(10) Pub. No.: US 2007/0296786 A1
(43) Pub. Date: Dec. 27, 2007

(54) Black ink composition, ink cartridge including the ink composition and ink jet recording apparatus including the ink cartridge

(75) Inventors: Cheol Ham, Yongi-si (KR); Seung-min Ryu, Yongin-si (KR); Hyo-keun Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/641,802

(22) Filed: Dec. 20, 2006

(30) Foreign Application Priority Data
Jun. 27, 2006 (KR) 10-2006-0058074

(51) Int. Cl. G01D 11/00; C09D 11/00; C09D 11/02

(52) U.S. Cl. 347/100; 106/31.51; 106/31.52; 106/31.48; 106/31.5; 106/31.58; 106/31.59

(57) ABSTRACT

A black ink composition includes a mixture of an azo metal complex dye having a good light fastness and water fastness and an adjective dye. The ink composition has a neutral black gradation, a high optical density and a good decap performance at a print head of an inkjet printer while printing. An inkjet cartridge for inkjet printing includes the black ink composition, and a recording apparatus for inkjet printing including the ink cartridge are also provided.

### CROSS-REFERENCE TO RELATED PATENT APPLICATION

This application claims the benefit under 35 U.S.C. § 119(a) of Korean Patent Application No. 10-2006-0058074, filed on Jun. 27, 2006, in the Korean Intellectual Property Office, the disclosure of which is incorporated by reference in its entirety.

### BACKGROUND OF THE INVENTION

1. Field of the Invention

The present invention relates to a black ink composition, an ink cartridge including the ink composition and an inkjet recording apparatus including the ink cartridge. More particularly, the invention relates to a black ink composition comprising a mixture of an azo metal complex dye having good light fastness and water fastness. The invention also relates to an adjective dye that has a neutral black gradation, a high optical density and a good decap performance at a print head while printing is performed. The invention is further directed to an ink cartridge including the ink composition and an inkjet recording apparatus including the ink cartridge.

2. Description of the Related Art

Various kinds of inks such as inks prepared by dissolving dyes in aqueous media or nonaqueous media, inks prepared by dispersing pigments in aqueous media or nonaqueous media, or solid inks in which thermolysis is possible can be used as ink for inkjet printing. Of these inks, inks prepared by dissolving dyes in aqueous media are mainly used, since these have a good coloring property and exhibit no harm in human bodies and the environment.

In particular, inkjet printers in which printing is simply performed in homes and offices are widely used. Inkjet printers having an image quality equivalent to that of silver photography have been developed. In order that such aqueous inks for inkjet printing maintain their performance for good printing for a long time, the inks should meet requirements such as light fastness, water fastness, purity, solubility, storage stability, viscosity, surface tension, conductivity, color strength, color tones and brightness and disclosed in U.S. Pat. No. 5,188,664.

The most important use for dyes is in ink. Even though many dyes are used, there are few dyes that meet requirements for inkjet printing.

In the past, traditional dyes used in foods, cloth and papers were converted to specific dyes for use in inkjet printing. Such dies included C.I. Food Black 2 used in ink as a black dye and compounds having a structure similar to that of C.I. Food Black 2. However, when printing was performed using these compounds, an unclear blueblack was produced, and water fastness was unsatisfactory. To minimize these disadvantages, substituents of C.I. Food Black 2 were converted to produce black dyes having more neutral black and improved water fastness as disclosed in U.S. Pat. No. 5,053,495. However, even though these black dyes have improved water fastness due to an introduction of a carboxyl group, a small amount of dye molecules permeate into the aqueous media or the dye molecules do not permeate into aqueous media at all. Thus, black inks formed from these black dyes do not have good rubfastness and light fastness.

By using tetraazo metal complex dyes such as diazo metal complex dyes and C.I. Direct Black 62 as disclosed in DE Patent Publication No. 19831095, or trisazo metal complex dyes as disclosed in U.S. Pat. No. 6,749,674 provide improved light fastness.

However, even though the azo metal complex dyes provide improved durability, they do not satisfy all the requirements. For example, colors of black inks are not neutral, and the optical density is unsatisfactory. In addition, the azo metal complex dyes have low storage stability, are inefficiently dissolved in a medium to be applied, and when printing is performed in inkjet printers by applying the dyes to ink, ink is dried on a surface of nozzles so that initial printing is not performed.

Decap time of ink denotes an amount of time that nozzles are blocked without printing when a print head is left uncapped. Nozzles can be blocked such that viscous materials or ink covers a surface of the nozzles, or dyes are crystallized. When nozzles are blocked, droplets of ink cannot be ejected from the nozzles or are ejected inaccurately, resulting in a bad printed image. Decap is often referred to as latency.

Since all of the nozzles of a print head are not always used in printing, printer service processes are required at intervals of time to prevent defective printed images. However, the printer service processes require ink consumption and decrease printing speed. Thus, the printer service processes should not be performed frequently. Therefore, ink needs to have a long decap time.

Accordingly, an ink is required to have better characteristics than those of conventional black ink in terms of light fastness, water fastness, solubility, storage stability, colors and optical density, and also that the ink has extra characteristics required for inkjet printing.

### SUMMARY OF THE INVENTION

The present invention provides a black ink composition comprising a mixture of an azo series metal complex dye having a good light fastness and water fastness and an adjective dye, which has a neutral black gradation, a high optical density and a good decap performance at a print head while printing is performed.

The present invention also provides an ink cartridge for inkjet printing including the black ink composition.

The present invention also provides a recording apparatus for inkjet printing including the ink cartridge for inkjet printing.

According to an aspect of the present invention, a black ink composition has an azo metal complex dye, an adjective dye and a solvent, wherein the adjective dye is at least one selected from the group consisting of Acid Blue 9, Direct Blue 86, Direct Blue 199, Reactive Red 23, Acid Red 52, Direct Red 75, Direct Violet 107, Reactive Red 180, Reactive Red 195, Direct Red 227 and Acid Red 289. The mixing weight ratio of the azo series metal complex dye and the adjective dye is about 50:1-2:1.

According to an embodiment of the present invention, the azo metal complex dye is Acid Black 194, Reactive Black 8, Reactive Black 31, Direct Black 62 or dyes represented by Formula 1 below:

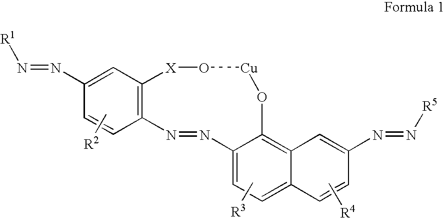

where X is a chemical bond, —CO— or —SO₂—;

R¹ is phenyl or naphthalene radical that is substituted with 1, 2 or 3 substituents selected from the group consisting of OH, O(C₁-C₆)-alkyl, COOM, SO₃M and NH₂;

R² is H, methyl or O(C₁-C₆)-alkyl;

R³ and R⁴ are each independently H, COOM or SO₃M;

R⁵ is phenyl, naphthyl, pyridyl or pyrazol radical that is substituted with 1, 2 or 3 substituents selected from the group consisting of OH, O(C₁-C₆)-alkyl, COOM, SO₃M, NH₂, NH-aryl, NH-acyl and phenylsulfo; and

M is H, Na, K, Li, Ca/2 (monovalent Ca) or an ammonium ion.

According to another embodiment of the present invention, a total amount of the azo metal complex dye and the adjective dye is about 1-10 weight % of the ink composition.

According to another aspect of the present invention, an ink cartridge for inkjet printing comprises the ink composition.

According to another aspect of the present invention, a recording apparatus for inkjet printing comprises the ink cartridge for inkjet printing.

The ink composition according to the present invention provides black ink composition having good light fastness, water fastness, solubility, storage stability, colors and high optical density.

These and other aspects of the invention will become apparent from the following detailed description which, when taken in conjunction with the annexed drawings, disclose various embodiments of the invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a side cross-sectional view of an ink cartridge including an ink composition according to an embodiment of the present invention; and

FIG. 2 is a perspective view of an inkjet recording apparatus including an ink cartridge having an ink composition, according to an embodiment of the present invention.

### DETAILED DESCRIPTION OF THE INVENTION

Hereinafter, the present invention will be described in detail by explaining embodiments of the invention with reference to the attached drawings.

A black ink composition according to an embodiment of the present invention comprises an azo metal complex dye, an adjective dye and a solvent, wherein the adjective dye is at least one of Acid Blue 9, Direct Blue 86, Direct Blue 199, Reactive Red 23, Acid Red 52, Direct Red 75, Direct Violet 107, Reactive Red 180, Reactive Red 195, Direct Red 227 and Acid Red 289, and where the weight ratio of the azo series metal complex dye and the adjective dye is about 50:1-2:1. These dyes are known in the art and are commercially available from various sources.

Examples of the azo metal complex dye include, but are not limited to monoazo, diazo, trisazo, tetraazo metal complex dye and the like, and more particularly Acid Black 194, Reactive Black 8, Reactive Black 31, Direct Black 62 and dyes represented by Formula 1 below.

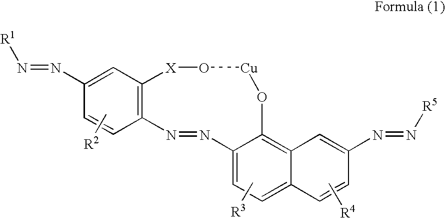

where X is a chemical bond, —CO— or —SO₂—;

R¹ is phenyl or naphthalene radical that is substituted with 1, 2 or 3 substituents selected from the group consisting of OH, O(C₁-C₆)-alkyl, COOM, SO₃M and NH₂;

R² is H, methyl or O(C₁-C₆)-alkyl;

R³ and R⁴ are each independently H, COOM, or SO₃M;

R⁵ is phenyl, naphthyl, pyridyl or pyrazol radical that is substituted with 1, 2 or 3 substituents selected from the group consisting of OH, O(C₁-C₆)-alkyl, COOM, SO₃M, NH₂, NH-aryl, NH-acyl and phenylsulfo; and

M is H, Na, K, Li, monovalent Ca or an ammonium ion. These dyes are known in the industry and are commercially available from various sources.

A total content of a dye is determined by the type of solvent in the dye, the characteristics required for ink, and the like. However, in general, the total amount of a dye is preferably about 1-10 weight % of an inkjet ink composition, and more preferably about 2-7 weight %. When the total amount of the dye is less than 1 weight %, desired optical density can not be obtained. When the total amount of the dye is greater than 10 weight %, a dissolved dye is extracted, thereby having low storage stability.

Ink including an azo metal complex dye alone has improved durability, however the ink does not have a neutral black tone and good optical density. Black can have color tones such as red, green, yellow and blue. A black ink without such color tones is regarded as neutral. When a color tone of black is neutral, high quality images can be obtained. In addition, black ink having high optical density can express more changes in black-white gradation, and thereby high quality images can be obtained.

The black ink composition according to the current embodiment of the present invention can neutralize color tones of such an azo metal complex dye by being mixed with an adjective dye, thereby having a neutral black tone. As a result, optical density of the black ink composition is significantly improved.

In addition, when printing is performed in an inkjet printer by applying the azo metal complex dye to ink, ink is dried on a surface of nozzles, and thus initial printing is not performed, that is, a decap time of the ink is short. However, according to an embodiment of the present invention, an adjective dye having a structure that is different from that of the azo metal complex dye is added to the ink, thus preventing the azo metal complex dye from easily being aggregated or crystallized. As a result, the decap performance of the ink is improved.

The black ink composition according to the current embodiment of the present invention can further include a surfactant. The surfactant is a cationic, anionic or nonionic surfactant, and preferably a nonionic surfactant because it has a good vesicular property. A preferable nonionic surfactant is SURFYNOL® series from Air Products and Chemicals Inc. having an acetylenic ethoxylated diol structure, TERGITOL® series from Union Carbide Corporation having a nonylphenol ethoxylate structure, and Tween series having a polyoxyethylene sorbitan fatty acid ester, and the like. In one embodiment, at least one of such nonionic surfactants is used. An amount of the surfactant is preferably about 0.05-3 weight % of the black ink composition. When the amount of the surfactant is less than about 0.05 weight %, surface tension of the black ink composition is so high that the black ink composition does not permeate into paper. When the amount of the surfactant is greater than about 3 weight %, ink leaks out to the surface of the nozzle when ink is ejected from a nozzle, and thus ejection can be interrupted. In addition, the black ink composition according to the current embodiment of the present invention includes water as a solvent. The water is preferably deionized water, but is not limited thereto. The amount of water is about 10-98 weight % of the black ink composition, and more preferably about 40-95 weight %. When the amount of water is less than about 10 weight %, the viscosity of the black ink composition is increased so that ejection performance is reduced. When the amount of water is greater than about 98 weight %, ink surface tension is excessively increased so that when printing is performed on general paper or special paper, and the like, ink characteristics such as permeability, dot forming capability and drying performance of printed images on the printing media are not good.

The black ink composition according to the current embodiment of the present invention can further include an aqueous organic solvent in addition to water as described as above as a solvent. The amount of the aqueous organic solvent is about 1-40 weight % of the black ink composition. When the amount of the aqueous organic solvent is less than about 1 weight %, ink surface tension is excessively increased so that when printing is performed on general paper or special paper, or the like, ink characteristics such as permeability, dot forming capability and drying performance of printed images on the printing media are not good. When the amount of the aqueous organic solvent is greater than about 40 weight %, viscosity of the ink composition is excessively increased so that ejection performance is reduced.

Examples of the aqueous organic solvent include an aliphatic monovalent alcohol, an aliphatic polyalcohol and aliphatic polyalcohol derivatives. When the aqueous organic solvent is added, the weight ratio of the water and the aqueous organic solvent is about 1:0.02-1. When the weight ratio of the aqueous organic solvent to water is less than about 0.02, ink surface tension is excessively increased so that ink characteristics such as permeability, dot forming capability and drying performance of printed images on the printing media are not good. When the weight ratio of the aqueous organic solvent to water is greater than about 1, viscosity of the black ink composition is excessively increased so that ejection performance is reduced.

The aliphatic monovalent alcohol in the current embodiment of the present invention improves permeability, dot forming capability and drying performance of printed images on the printing media by adjusting surface tension of the black ink composition. In addition, the aliphatic polyalcohol and derivatives thereof in the current embodiment of the present invention do not easily evaporate and lower the freezing point of the black ink composition, thereby improving storage stability of the black ink composition at a low temperature to prevent nozzles from being blocked.

Examples of the aliphatic monovalent alcohol include C₁-C₁₀ lower alcohols such as methyl alcohol, ethyl alcohol, n-propyl alcohol, i-propyl alcohol, n-butyl alcohol, s-butyl alcohol and t-butyl alcohol, and mixtures thereof. Preferably, monovalent alcohol is ethyl alcohol, i-propyl alcohol or n-butyl alcohol.

In addition, examples of the aliphatic polyalcohol include alkyleneglycol such as ethyleneglycol, diethyleneglycol, triethyleneglycol, propyleneglycol, butyleneglycol and glycerol. Other aliphatic polyalcohols include polyalkyleneglycols such as polyethyleneglycol and polypropyleneglycol; thiodiglycols; and mixtures thereof.

In addition, examples of the aliphatic polyalcohol derivatives include lower alkylethers of the aliphatic polyalcohol and lower carboxylic esters of the aliphatic polyalcohol. More particularly, the lower alkylethers of the aliphatic polyalcohol can be ethyleneglycoldimethylether. The lower carboxylic esters of the aliphatic polyalcohol can be ethyleneglycoldiacetate.

The black ink composition according to the current embodiment of the present invention can further include additives such as a viscosity controller, a pH adjuster, a preservative, a chelating agent or the like, which are conventionally used in an ink composition, in addition to the components as described above.

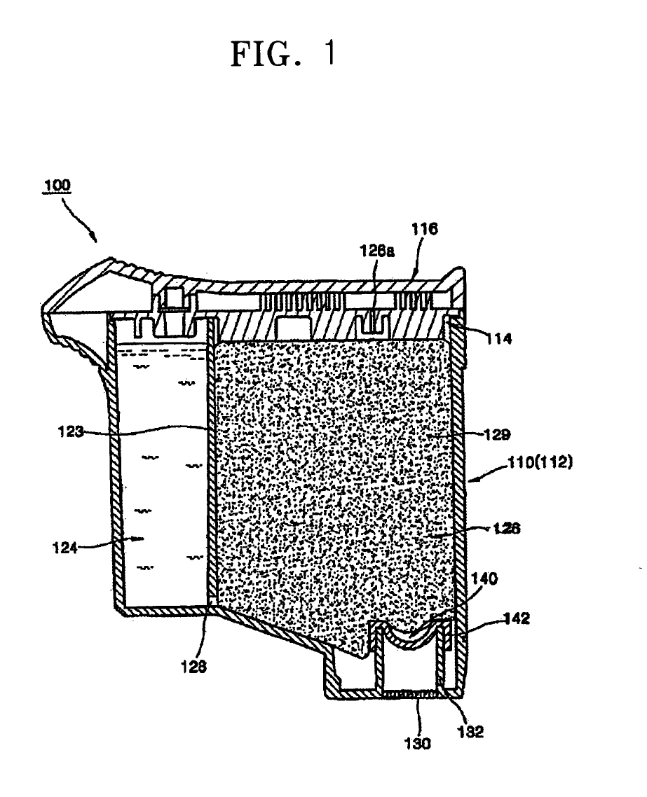

The black ink composition according to the current embodiment of the present invention can be used in toner compositions, various paints, coating liquids and the like in addition to ink cartridges for inkjet printing, and its use is not particularly limited. Preferably, the black ink composition can be used in an inkjet printer cartridge employing an array head. An array-type inkjet printer prints at high speed using a plurality of chips unlike a shuttle-type inkjet printer that prints while moving one chip, so that processing capacity of a recording apparatus can be increased and printing can be effectively performed when the black ink composition according to the current embodiment of the present invention is used. The present invention provides an ink cartridge for inkjet printing including the black ink composition according to the current embodiment of the present invention. Hereinafter, an ink cartridge for inkjet printing according to an embodiment of the present invention will be described in more detail with reference to FIG. 1.

FIG. 1 is a cross-sectional side view of an ink cartridge 100 including an ink composition according to an embodiment of the present invention.

Referring to FIG. 1, the ink cartridge 100 for inkjet printing according to the current embodiment of the present invention includes an ink cartridge main body 110 including an ink supply tank 112, an inner cover 114 covering a top portion of the ink supply tank 112, an outer cover 116 that is separated from the inner cover 114 by a predetermined gap in order to seal the ink supply tank 112 and the inner cover 114.

The ink supply tank 112 is partitioned into a first chamber 124 and a second chamber 126 by a vertical barrier wall 123. An ink passage 128 is formed in a bottom portion of the vertical barrier wall 123 between the first chamber 124 and the second chamber 126. The first chamber 124 is filled with the black ink composition according to an embodiment of the present invention, and the second chamber 126 is filled with a sponge and the black ink composition. A vent hole 126a is formed in the inner cover 114 to vent the second chamber 126. A filter 140 is provided at the bottom of the second chamber 126 and filters impurities and micro bubbles in the ink to prevent clogging of nozzles of a printer head 130. A hook 142 is formed on an edge of the filter 140 and is coupled to an upper portion of a standpipe 132. The black ink composition according to an embodiment of the present invention stored in the first chamber 124 and the second chamber 126 is ejected through the nozzles of the printer head 130 onto a printing medium in the form of small droplets when a recording apparatus is operated.

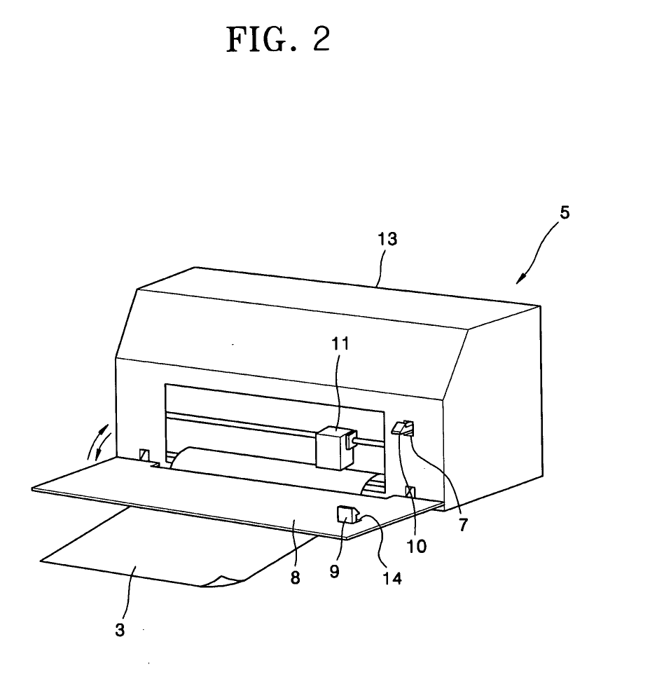

The present invention also provides a recording apparatus for inkjet printing including the ink cartridge for inkjet printing. Hereinafter, the recording apparatus for inkjet printing according to an embodiment of the present invention will be described in more detail with reference to FIG. 2.

FIG. 2 is a perspective view of an inkjet recording apparatus 5 including an ink cartridge 11 having a black ink composition, according to an embodiment of the present invention. Referring to FIG. 2, the inkjet recording apparatus 5 according to the current embodiment of the present invention including the ink cartridge 11 has a black ink composition that contains an azo metal complex dye, an adjective dye, a solvent, and a surfactant. A cover 8 of the inkjet recording apparatus 5 is connected to a main body 13 of the inkjet recording apparatus 5 by a hinge. An engaging portion of a movable latch 10 protrudes through a hole 7. The movable latch 10 engages with a fixed latch 9. The fixed latch 9 is coupled to an inner side of the cover 8 when the cover 8 is closed. The cover 8 has a recess 14 in a region corresponding to the engaging portion of the movable latch 10 protruding through the hole 7. The ink cartridge 11 is mounted such that ink can be ejected onto paper 3 passing under the ink cartridge 11.

As described above, the present invention provides a black ink composition, an ink cartridge for inkjet printing including the black ink composition, and a recording apparatus for inkjet printing including the ink cartridge. The black ink composition comprises a mixture of an azo metal complex dye having a good light fastness and water fastness and an adjective dye, and has a neutral black gradation, a high optical density and a good decap performance at a print head while printing is performed.

The present invention will be described in greater detail with reference to the following examples. The following examples are for illustrative purposes only and are not intended to limit the scope of the invention.

### EXAMPLES

Ink compositions according to Examples 1 through 5 were prepared by completely mixing materials listed in Examples 1 through 5 below using a mixer. Viscosity was measured using a Brookfield viscometer at 25° C., and surface tension was measured using a Kruss K-12 tensiometer (Wilhelmy plate method) at 25° C.

### Example 1

| | |
|---|---|
| C.I. Acid Black 194 | 4.5 weight % |
| C.I. Acid Blue 9 | 0.4 weight % |
| C.I. Reactive Red 23 | 0.6 weight % |
| Glycerol | 10 weight % |
| Diethyleneglycol | 8 weight % |
| Nonionic surfactant | 1.5 weight % |
| (Product: Surfynol 440, Air Products Corporation) | |
| Water (deionized water) | the remainder |

### Example 2

| | |
|---|---|
| C.I. Reactive Black 8 | 4.3 weight % |
| C.I. Direct Red 75 | 0.6 weight % |
| Glycerol | 9 weight % |
| Diethyleneglycol | 6 weight % |
| Ethyleneglycol | 2 weight % |
| Nonionic surfactant | 0.8 weight % |
| (Product: Tween 20, Aldrich Corporation) | |
| Water (deionized water) | the remainder |

### Example 3

| | |
|---|---|
| C.I. Reactive Black 31 | 4.2 weight % |
| C.I. Direct Blue 86 | 0.7 weight % |
| Diethyleneglycol | 9 weight % |
| Ethyleneglycol | 7 weight % |
| Nonionic surfactant | 0.9 weight % |
| (Product: Surfynol 465, Air Products Corporation) | |
| Water (deionized water) | the remainder |

### Example 4

| | |
|---|---|
| Azo metal complex dye of Formula 1 | 5.1 weight % |
| (Product: Duasynjet Black NB SF, Clariant Corporation) | |
| C.I. Direct Blue 86 | 0.4 weight % |
| C.I. Direct Red 227 | 0.6 weight % |
| Glycerol | 7 weight % |
| Diethyleneglycol | 6 weight % |
| Ethyleneglycol | 5 weight % |
| Nonionic surfactant | 0.8 weight % |
| (Product: Tween 40, Aldrich Corporation) | |
| Water (deionized water) | the remainder |

### Example 5

| | |
|---|---|
| C.I. Direct Black 62 | 4.4 weight % |
| C.I. Acid Red 52 | 0.5 weight % |
| Glycerol | 4 weight % |
| Diethyleneglycol | 5 weight % |
| Ethyleneglycol | 7 weight % |
| Nonionic surfactant | 0.5 weight % |
| (Product: Tergitol NP-30, Union Carbide Corporation) | |
| Water (deionized water) | the remainder |

Ink compositions for inkjet printing according to Comparative Examples 1 through 5 were prepared by completely mixing materials listed in Comparative Examples 1 through 5 below using a mixer.

### Comparative Example 1

| | |
|---|---|
| C.I. Acid Black 194 | 5.5 weight % |
| Glycerol | 10 weight % |
| Diethyleneglycol | 8 weight % |
| Nonionic surfactant | 1.5 weight % |
| (Product: Surfynol 440, Air Products Corporation) | |
| Water (deionized water) | the remainder |

### Comparative Example 2

| | |
|---|---|
| C.I. Reactive Black 8 | 4.9 weight % |
| Glycerol | 9 weight % |
| Diethyleneglycol | 6 weight % |
| Ethyleneglycol | 2 weight % |
| Nonionic surfactant | 0.8 weight % |
| (Product: Tween 20, Aldrich Corporation) | |
| Water (deionized water) | the remainder |

### Comparative Example 3

| | |
|---|---|
| C.I. Reactive Black 31 | 4.9 weight % |
| Diethyleneglycol | 9 weight % |
| Ethyleneglycol | 7 weight % |
| Nonionic surfactant | 0.9 weight % |
| (Product: Surfynol 465, Air Products Corporation) | |
| Water (deionized water) | the remainder |

### Comparative Example 4

| | |
|---|---|
| Azo metal complex dye of Formula 1 | 6.1 weight % |
| (Product: Duasynjet Black NB SF, Clariant Corporation) | |
| Glycerol | 7 weight % |
| Diethyleneglycol | 6 weight % |
| Ethyleneglycol | 5 weight % |
| Nonionic surfactant | 0.8 weight % |
| (Product: Tween 40, Aldrich Corporation) | |
| Water (deionized water) | the remainder |

### Comparative Example 5

| | |
|---|---|
| C.I. Direct Black 62 | 4.9 weight % |
| Glycerol | 4 weight % |
| Diethyleneglycol | 5 weight % |
| Ethyleneglycol | 7 weight % |
| Nonionic surfactant | 0.5 weight % |
| (Product: Tergitol NP-30, Union Carbide Corporation) | |
| Water (deionized water) | the remainder |

Latency Evaluation

Latency (decap time) was determined in the following manner using a Samsung MJC-3300P printer which is converted not to service an ink cartridge during evaluation.

A nozzle inspection pattern was printed before evaluation to confirm that ink was ejected from all the nozzles. When a print head moved across the width of a sheet of paper once, 51 vertical lines were printed. Each vertical line was formed when a droplet of ink was ejected from all the nozzles, and thus the vertical line had a width corresponding to the droplet of ink. After a predetermined latency time, a first vertical line was formed by a droplet of ink that was initially ejected from each nozzle.

Pattern printing was repeated at gradually increasing time intervals of 1, 2, 3, 4, 5, 6, 7, 8, 9, 10, 20, 30, 40, 50, 60, 70, 80, 90, 100, 200, 300, 400, 500 and 600 seconds. The longest time interval in which a first vertical line was printed without error is the decap time.

TABLE 1

| Property | Example 1 | Example 2 | Example 3 | Example 4 | Example 5 |
|---|---|---|---|---|---|
| Surface | 35 | 36 | 35 | 34 | 36 |
| tension | | | | | |
| (mN/m) | | | | | |
| Viscosity | 2.6 | 2.9 | 2.4 | 3.1 | 2.8 |
| (cps) | | | | | |
| pH | 7.6 | 7.4 | 6.1 | 6.5 | 6.3 |
| Optical | 0.72 | 0.74 | 0.69 | 0.73 | 0.76 |
| density | | | | | |
| Decap time | 60 | 100 | 90 | 50 | 70 |
| (seconds) | | | | | |

TABLE 2

| | Comparative | Comparative | Comparative | Comparative | Comparative |
|---|---|---|---|---|---|
| Property | Example 1 | Example 2 | Example 3 | Example 4 | Example 5 |
| Surface Tension | 33 | 38 | 37 | 35 | 35 |
| (mN/m) | | | | | |
| Viscosity (cps) | 2.5 | 2.6 | 2.5 | 3.0 | 2.7 |
| pH | 7.3 | 7.7 | 6.5 | 6.9 | 5.5 |
| Optical density | 0.61 | 0.62 | 0.56 | 0.64 | 0.68 |
| Decap time | 10 | 20 | 8 | 10 | 7 |
| (seconds) | | | | | |

As can be seen from the results of Tables 1 and 2, when the ink compositions according to Examples 1 through 5 are used in inkjet printing, all the ink compositions have good optical density, decap time and printed images. That is, the ink compositions according to Examples 1 through 5 have high optical density and good decap performance at a print head during printing compared to the ink compositions according to Comparative Examples 1 through 5 that do not use any adjective dyes.

The black ink composition according to the present invention comprises a mixture of an azo metal complex dye having a good light fastness and water fastness and an adjective dye, has a neutral black gradation, a high optical density and a good decap performance at a print head while printing is performed.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A black ink composition comprising an azo metal complex dye, an adjective dye and a solvent, wherein the adjective dye is at least one of Acid Blue 9, Direct Blue 86, Direct Blue 199, Reactive Red 23, Acid Red 52, Direct Red 75, Direct Violet 107, Reactive Red 180, Reactive Red 195, Direct Red 227 and Acid Red 289, wherein a weight ratio of the azo metal complex dye and the adjective dye is about 50:1-2:1.

2. The black ink composition of claim 1, wherein the azo metal complex dye is Acid Black 194, Reactive Black 8, Reactive Black 31, Direct Black 62 or dyes represented by Formula 1 below: 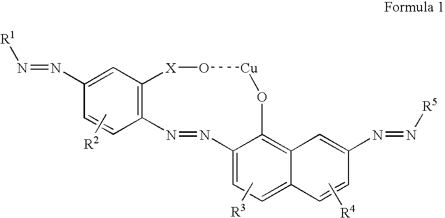
where X is a chemical bond, —CO— or —SO₂—;
R¹ is phenyl or naphthalene radical that is substituted with 1, 2 or 3 substituents selected from the group consisting of OH, O(C₁-C₆)-alkyl, COOM, SO₃M and NH₂;
R² is H, methyl or O(C₁-C₆)-alkyl;
R³ and R⁴ are each independently H, COOM or SO₃M;
R⁵ is phenyl, naphthyl, pyridyl or pyrazol radical that is substituted with 1, 2 or 3 substituents selected from the group consisting of OH, O(C₁-C₆)-alkyl, COOM, SO₃M, NH₂, NH-aryl, NH-acyl and phenylsulfo; and
M is H, Na, K, Li, monovalent Ca or an ammonium ion.

3. The black ink composition of claim 1, wherein a total amount of the azo metal complex dye and the adjective dye is about 1-10 weight % of the black ink composition.

4. The black ink composition of claim 1, further comprising a surfactant.

5. The black ink composition of claim 4, wherein the surfactant is at least one selected from the group consisting of acetylenic ethoxylated diol, nonylphenol ethoxylate, and polyoxyethylene sorbitan fatty acid ester, wherein an amount of the surfactant is about 0.05-3 weight % of the black ink composition.

6. An ink cartridge for inkjet printing comprising the black ink composition according to claim 1.

7. A recording apparatus for inkjet printing comprising the ink cartridge for inkjet printing of claim 6.
